(19) United States
(12) Patent Application Publication
(10) Pub. No.: US 2025/0380705 A1
(43) Pub. Date: Dec. 18, 2025

(54) SUPERREPELLENT DOUBLY REENTRANT TOPOLOGY (DRT) SURFACE FOR PROMOTING ANTIBIOFOULING AND PREVENTION OF VIRUS CONTAMINATION

(71) Applicant: Taipei Veterans General Hospital, Taipei City (TW)

(72) Inventors: Shih-Jie CHOU, Taipei City (TW); Meng-Shiue LEE, Taipei City (TW); Yi-Ping YANG, Taipei City (TW); Yueh CHIEN, Taipei City (TW); Shih-Hwa CHIOU, Taipei City (TW)

(73) Assignee: Taipei Veterans General Hospital, Taipei City (TW)

(21) Appl. No.: 18/745,823

(22) Filed: Jun. 17, 2024

(51) Int. Cl. A01N 59/20; A01P 1/00

(52) U.S. Cl. CPC A01N 59/20; A01P 1/00

(57) ABSTRACT

Doubly reentrant topology (DRT) is a unique structure. The present invention first validated the outstanding performance of an anti-biofouling artificial surface comprising a superhydrophobic surface; thereon a plurality of microstructures and having a doubly re-entrant topology (DRT) situated atop respective base structures which demonstrates a striking anti-biofouling effect that can prevent viral contamination. Furthermore, the present invention per se features excellent anti-biofouling ability, which may shed light on the applications of pathogen elimination in alleviating the COVID-19 pandemic.

### FIELD OF THE INVENTION

The present invention relates to a designed doubly reentrant topology (DRT) geometric surface to promote anti-biofouling and prevention of coronavirus contamination.

### BACKGROUND OF THE INVENTION

Since the outbreak of severe acute respiratory syndrome coronavirus 2 (SARS-CoV-2), developing strategies to prevent viral transmission has become an urgent and unmet need to alleviate the coronavirus disease 2019 (COVID-19) pandemic. Although SARS-CoV-2 is mainly transmitted by exposure to infectious respiratory droplets and aerosol particles,^{[1]} further studies have suggested prolonged survival of SARS-CoV-2 on inanimate objects.^{[2]} This raises the issue of fomite transmission of SARS-CoV-2, which poses high biohazard risks to healthcare workers especially.^{[3]} Therefore, special surfaces have been extensively developed to reduce viral transmission. Researchers have applied a variety of coating agents, including copper,^{[4-6]} cationic polymers,^{[7]} photodynamic polymers,^{[8]} hydrogels,^{[9]} nanoparticles,^{[4,5,10]} graphene,^{[4,11]} etc., on surfaces. Among them, copper has been reported to have an outstanding ability to kill micro-organisms^{[12]} and viruses such as SARS-CoV-2.^{[13]} Thus, it has regained attention as an effective material for eliminating SARS-CoV-2.^{[14]}

Besides, superhydrophobic surfaces are also considered an alternative strategy to reduce pathogen transmission. In the 1940s, Cassie and Baxter observed that water droplets roll off ducks' feathers because of the feathers' structure with densely packed particles.^{[15]} Other natural examples include lotus leaves, Salvinia, mosquito eyes, and cicada wings.^{[16]} Water droplets easily roll off these surfaces and can carry away dust or micro-organisms, achieving a self-cleaning effect and maintaining the function of surfaces. Subsequently, surfaces with randomly distributed or densely packed particles/pillars have been applied to various superhydrophobic systems.^{[17]} The nonspecific adsorption or accumulation of undesired microbes and biomolecules on surfaces is also known as biofouling, which causes the degradation of materials and facilitates the transmission of pathogens.^{[18]} This highly limits the applications of superhydrophobic surfaces. Current anti-biofouling surfaces still mainly rely on specific coating agents with/without superhydrophobic properties. Degradation of these coatings will severely impact the surfaces' antibiofouling performance. Thus, developing a novel antibiofouling surface independent of hydrophobic or antiviral coatings is essential to accomplish long-term prevention of viral transmission. This kind of antibiofouling surface can be applied in different fields more broadly because it does not require specific coating agents.

Liu et al. designed a unique doubly reentrant topology (DRT) geometry with superrepellency. The DRT surface can repel liquids with extremely low surface energy (i.e., γ<15 mJ m⁻²)^{[19]}, such as fluorinated solvents that can thoroughly wet almost all of the existing materials.^{[20]} Without chemical modifications, the DRT surface, even made of hydrophilic materials like silicon dioxide (SiO₂), could repel perfluorohexane (C₆F₁₄, also known as 3M™ Fluorinert™ FC-72) with a surface energy of 10 mJ m⁻².^{[20_]} These features make DRT a good candidate for antibiofouling surfaces independent of hydrophobic coatings. The DRT is a mushroom-like structure, of which the second reentrant sidewall in nanoscale provides optimal upward force for liquid suspension. As long as the DRT geometry is intact, it can theoretically repel all kinds of liquids, even for extremely-low-energy liquids with an intrinsic contact angle (i.e., Young's angle) of almost zero. Unlike conventional methods of manufacturing superhydrophobic surfaces, a hydrophobic agent or coating is no longer required to fabricate DRT surfaces.^{[20]} This novel design has been a breakthrough and provided new insights into the field of superhydrophobic materials. However, the antifouling potential of DRT surfaces against different biomolecules and their biomedical applications remain undetermined despite its reported superrepellency nature.

### SUMMARY OF THE INVENTION

The present invention relates to a designed doubly reentrant topology (DRT) geometric structure to promote anti-biofouling and prevention of coronavirus contamination.

In the present invention, an anti-biofouling artificial surface comprising: a superhydrophobic surface; thereon a plurality of microstructures and having a doubly re-entrant topology (DRT) situated atop respective base structures, wherein the doubly re-entrant topology (DRT) comprises a cap portion, a downwardly extending lip extending from a periphery of the cap portion and a copper coating layer; wherein the superhydrophobic surface roughness of large contact angles and lower hysteresis angle.

In one aspect, the present invention provides the superhydrophobic surface roughness of large contact angles is less than 150° and the thickness of the cap portion is substantially equal to the thickness of the downwardly extending lip.

In one embodiment of the present invention, the base material comprises silicon and the cap material comprises silicon dioxide.

In one embodiment of the present invention, the superhydrophobic surface remains repellant to fouling fluids and anti-biofouling properties after long-term exposure.

In one example of the present invention, the copper coating comprises copper and its alloys; the copper coating comprises copper and its alloys.

In one example of the present invention, the superhydrophobic surface comprises whether hydrophobic or hydrophilic material.

In a further aspect, the present invention provides a method of promoting anti-biofouling and prevention of pathogens comprising using an anti-biofouling artificial surface comprising:
a superhydrophobic surface; thereon a plurality of microstructures and having a doubly re-entrant topology (DRT) situated atop respective base structures, wherein the doubly re-entrant topology (DRT) comprises a cap portion, a downwardly extending lip extending from a periphery of the cap portion and a copper coating layer; wherein the superhydrophobic surface roughness of large contact angles and lower hysteresis angle.

In one embodiment of the present invention, the pathogen is an infectious microorganism or agent comprising a virus, bacterium, protozoan, prion, viroid, or fungus.

In one example of the invention, wherein the virus is SARS-CoV-2.

The features and advantages of the present invention will be apparent to those skilled in the art. While numerous changes may be made by those skilled in the art, such changes are within the scope of this invention.

### BRIEF DESCRIPTION OF THE DRAWINGS

The foregoing summary, as well as the following detailed description of the invention, will be better understood when read in conjunction with the appended drawings. The purpose of illustrating the invention, there are shown in the drawings embodiments which are presently preferred. It should be understood, however, that the invention is not limited to the precise arrangements and instrumentalities shown.

In the drawings:

FIG. 1 illustrates that (a) Illustration of liquids on the PS, SCS, and DRT surface. (b) Scanning electron microscopy (SEM) imaging of different surfaces.

FIG. 2 illustrates that (a) The contact angle of various biomolecules on different surfaces. (b) The contact region of liquid on a surface. (c) The ratio of the real contact area (i.e., liquid-solid area) to the (liquid volume)^{2/3} vs. intrinsic contact angle (i.e., Young's angle). Abbreviations: DRT, doubly reentrant topology; fₛ, the liquid-solid fraction; PS, plain surface.

FIG. 3 illustrates the antifouling effect of different surfaces. (a) Blood was suspended on the DRT surface but not PS or SCS. Quantification of (b) adherent protein, (n=3 at each point), (c) blood (n=5 at each point), (d) bacteria (n=3 at each point), and (e) viruses (n=3 at each point) on different surfaces. Data shown in are mean±standard deviation (SD). Denotation: ns, p>0.05; *p≤0.05; **p≤0.01; ***p≤0.001; ****p≤0.0001 vs. SiO₂-DRT alone.

FIG. 4 illustrates the SEM images of bacteria and viruses on different surfaces. For the DRT surface, we concentrated the bacterial and viral solution of 500× and 100×, respectively, because the initial concentration could not yield visible pathogens on the DR surface.

FIG. 5 illustrates the comparison of adherent bacteria and viruses on SiO₂ and Cu-coated surfaces. (a) The appearance of the SiO₂-DRT and Cu-DRT surface. (b) The adherent bacteria number on the SiO₂-PS and Cu-PS (n=3 at each point). (c) The adherent viral particle number on the SiO₂-PS and Cu-PS (n=6 at each point). (d) The adherent bacteria number on the SiO₂-DRT and Cu-DRT surface (n=3 at each point). (e) The adherent viral particle number on the SiO₂-DRT and Cu-DRT surface (n=6 at each point). Data shown are mean±SD. Denotation: ns, p>0.05; *p≤0.05; **p≤0.01; ***p≤0.001; ****p≤0.0001 vs. SiO₂-DRT alone.

FIG. 6 illustrates the liquid suspension on the SCS and DRT surface. The liquid suspension is achieved through the upward surface tension. Under the condition as intrinsic contact angle of <90°, the liquid immerses the structure of SCS but is suspended on the DRT surface.

FIG. 7 illustrates the key geometric parameters of the DRT surface. D is the post top diameter, P is the center-to-center distance (i.e., pitch) between the adjacent posts, and δ and t are the length and thickness, respectively, of the overhang. The fabricated DRT surface is a square array of circular posts with D˜10 μm, P˜50 μm, δ˜1.5 μm, and t˜300 nm.

FIG. 8 illustrates the setup of contact angle measurement.

FIG. 9 illustrates the antifouling effect of different surfaces against protein fouling. (a) The test for antibiofouling of protein on surfaces. The protein solution with fluorescence reporter was placed on the surfaces for different duration. Then, we measured the fluorescence intensity of adherent proteins on the surfaces and defined it as the protein fouling. (b) The fluorescence microscopy imaging showing the protein biofouling on different surfaces.

FIG. 10 illustrates the antifouling effect of different structured surfaces against blood. (a) A representative colorimetric analysis of hemoglobin in the droplets recycled from different surfaces. (b) Quantification of hemoglobin in the recycled blood droplet from different surfaces.

FIG. 11 illustrates the antifouling effect of different surfaces against bacteria. (a) Comparison of colony formation in the plates spread by the adherent bacteria recycled from different surfaces. Adherent bacteria were detached by trypsinization. (b) Determination of bacteria concentration on the SiO₂-PS, SiO₂-SCS, and SiO₂-DRT surface using a spectrophotometric method of 600 nm wavelength. (c) The amount of the adherent bacteria was calculated and estimated by subtracting droplet bacteria from the loading bacteria.

FIG. 12 illustrates the antifouling effect of different surfaces against viruses. (a) After placed on the surfaces, the virus droplets were recycled and subjected to infecting ACE2-overexpressing HEK293T cells. The luciferase expression was evaluated using qPCR. (b) Comparison of viral replicative activity from the virus droplets on different surfaces.

FIG. 13 illustrates that (a) The elemental analysis of SiO₂-DRT, and Cu-DRT. (b) The dynamic contact angle measurement of DRT surfaces. For all test bioliquids, all advancing angles are larger than 150°, and all receding angles are around 150°.

FIG. 14 illustrates that (a) Comparison of colony formation in the plates spread by the adherent bacteria recycled from different surfaces with or without copper coating. Adherent bacteria were detached by trypsinization. The bacterial fouling with or without the copper coating was assessed using the CFU method. (b) Adherent viruses were detached by trypsinization. Luciferase reporter assay showed the virus replicative activity from the virus-containing droplets or adhesive viruses on surfaces with or without copper coating.

FIG. 15 illustrates the fabrication process of (a) PS, (b) SCS, and (c) DRT surface.

### DETAILED DESCRIPTION OF THE INVENTION

The above summary of the present invention will be further described with reference to the embodiments of the following examples. However, it should not be understood that the content of the present invention is only limited to the following embodiments, and all the inventions based on the above-mentioned contents of the present invention belong to the scope of the present invention.

Unless defined otherwise, all technical and scientific terms used herein have the same meaning as commonly understood by a person skilled in the art to which this invention belongs.

As used herein, the singular forms “a”, “an”, and “the” include plural referents unless the context clearly dictates otherwise. Thus, for example, reference to “a sample” includes a plurality of such samples and equivalents thereof known to those skilled in the art.

The present invention possesses a striking anti-biofouling effect that can prevent viral contamination.

The embodiment of the invention shows that the anti-biofouling effect still exists even if the doubly re-entrant topology (DRT) surface is made of a hydrophilic material such as silicon oxide and copper which first demonstrates that fomite transmission of viruses may be prevented by minimizing the contact area between pathogens and surfaces even made of hydrophilic materials.

Furthermore, the DRT geometry per se features excellent anti-biofouling ability, which may shed light on the applications of pathogen elimination in alleviating the COVID-19 pandemic.

The following embodiments are made to clearly exhibit the above-mentioned and other technical contents, features and effects of the present invention. As the contents disclosed herein should be readily understood and can be implemented by a person skilled in the art, all equivalent changes or modifications which do not depart from the concept of the present invention should be encompassed by the appended claims.

### Embodiment

### Methods

### Test Liquid Preparation

To examine the antifouling potential of various fabricated surfaces, we prepared five tested liquids, including ddH₂O, protein solution, a human blood sample, bacterial solution, and viral solution. The protein solution was prepared from the goat anti-rabbit IgG (H+L) cross-adsorbed secondary antibody, Alexa Fluor 647 (Thermo Fisher Scientific, MA, USA), with a 2 mg/mL concentration. The blood sample was drawn from a healthy donor in an acid citrate dextrose (ACD) tube from BD Vacutainer®. The peripheral blood from the healthy donor was collected following the Ethical and Institutional Review Board of Taipei Veterans General Hospital (ID No. 2020-07-036CC and 2020-05-004C). The informed written consent from the donor was obtained before the research. The bacterial solution was prepared by mixing Escherichia coli (E. coli) with PBS buffer. The E. coli was obtained from National RNAi Core from Academia Sinica in Taiwan. Once the bacteria stock solution (ECOSTM, Yeastern Biotech Co., Ltd., Taiwan) was thawed from a −80° C. freezer, we amplified it with TB buffer (Won-Won Biotechnology Co., Ltd., Taiwan). We incubated it in the incubator shaker at 37° C. overnight. The bacteria mixture was collected after 18 hours and centrifuged at 3,000 rpm for 10 minutes. The pallet was resuspended in 1 mL PBS and was quantified by NanoPhotometer® N60 (Implen Inc., CA, USA) by regression analysis. The SARS-CoV-2 pseudovirus from National RNAi Core from Academia Sinica in Taiwan was used for the viral solution. The SARS-CoV-2 pseudovirus was packed using a lentiviral backbone, a plasmid-encoding luciferase sequence, and a plasmid-expressing spike(S) protein as the surface glycoprotein of the viral envelope. The minimal plasmid set of lentiviral protein (Tat, Gal-Pol, and Rev) was used to assemble viral particles, and the CMV promoter was used to drive GFP expression. The viral solution was prepared by mixing SARS-CoV-2 pseudoviruses with DMEM. We put 20 μL of solution (protein, hemoglobin, bacteria, and virus) on surfaces in each experiment.

### Fabrication of the Plain Surface (PS), Simple Column Surface (SCS), Doubly Reentrant Topology (DRT), and Copper-Coated DRT (Cu-DRT)

The fabrication process of the PS was only one step. First, one μm of silicon dioxide was deposited through thermal oxidation. The fabrication process of the SCS comprises five main steps, starting from a silicon wafer. First, the 1-μm silicon dioxide is deposited through thermal oxidation. Second, the photoresist layer was patterned through lithography. Third, the 1-μm silicon oxide was anisotropically etched through the reactive-ion etching (RIE). Fourth, the photoresist residue was removed through the piranha solution. Finally, the 0.3-μm silicon dioxide was grown through thermal oxidation.

The fabrication process of the DRT is started from a silicon wafer, comprising eight main steps as follows. First, the 1-μm silicon dioxide was deposited through thermal oxidation. Second, the photoresist layer was patterned through lithography. Third, the 1-μm silicon dioxide and the 1.5-μm silicon were anisotropically etched through RIE. Fourth, the photoresist residue was removed through the piranha solution. Fifth, the 0.3-μm silicon dioxide was deposited through thermal oxidation. Sixth, the 0.3-μm silicon dioxide was anisotropically etched through RIE. Seventh, the 25-μm silicon was anisotropically etched through RIE, and the 2-μm silicon was isotropically etched through RIE. Finally, 0.3-μm silicon dioxide was grown through thermal oxidation.

### Evaluation of Protein Fouling on the Surfaces

The Goat anti-Rabbit IgG (H+L) Cross-Adsorbed Secondary Antibody, Alexa Fluor 647 (thermal fisher, 1:200), was used as the protein solution. The solution was spotted on the PS, SCS, and DRT surfaces at a volume of 20 μL. After different time intervals, PBS was used to wash the surface. The inverted microscope Olympus IX73 was used to capture the fluorescent pictures. The exposure time was 4 sec. The adhesion of protein was quantified using the Image J software. Evaluation of hemoglobin fouling on the surfaces

The adhesion of blood was evaluated and calculated by the fixed amount of 20 μL of blood droplet minus recycled blood amount. The hemoglobin was detected using the Bio Vision Hemoglobin Colorimetric Assay (Catalog #K219, BioVision, Inc., CA, US). First, human blood (donated from a healthy donor) was spotted on surfaces at a volume of 20 μL. Then, after different time intervals, 180 μL PBS was added onto the surface to dilute and recycle the blood. Each collected blood sample was further added with an equal volume of ddH₂O to adjust the concentration. The standard curve was constructed with the Hemoglobin Standard provided in the commercial kit, and 20 μL of each sample was added per well, followed by adding 180 μl Hemoglobin Detector to present the color complex. The absorbance at 575 nm was measured with SpectraMax® M3 Multi-Mode Microplate Reader (Molecular Devices, Sunnyvale, CA, USA), and the concentration was calculated using the standard curve.

### Evaluation of Bacterial Fouling on the Surfaces

The stocked DH5 alpha strain of E. coli was thawed at room temperature from −80° C. and cultured in LB broth (WonWon, Taiwan). After 18 hours of shaking in 37° C. incubation, one mL of bacteria LB solution was taken and spun down (Kubota, Bunkyo-ku, Tokyo) at 3000 rpm. Next, we discarded the supernatant and resolved the pellet in 500 μL PBS solution. The initial bacterial concentration was measured according to 600 nm wavelengths with the NanoPhotometer® (IMPLEN, USA).

For the biofouling test, 20 μL of the prepared bacterial solution with fixed concentration was loaded onto various fabricated surfaces. At the end of incubation, 500 μL PBS washing solution was added to the remnant bacterial droplets. Then the bacteria-containing washing buffer was collected and subjected to the following analyses and assays. The washing buffer was analyzed using NanoPhotometer® to evaluate bacterial concentration at 600 nm wavelengths.

The 10 cm Petri dishes (Falcon, USA) were covered with 10 mL of sterilized LB agar (Cyrusbioscience, Taiwan). The bacteria-containing washing buffer from the fabricated surfaces was diluted using PBS buffer after gelation. Ten μL of the diluted washing buffer was resuspended in 100 μL LB buffer (the final dilution ratio=1:5×10⁴) and spread onto the LB agar plates. After 18-hour incubation under 37° C., the adherent bacteria on the fabricated surfaces were detached using 200 μL trypsin and diluted in PBS buffer. Ten μL of the diluted buffer containing the detached bacteria was resuspended in 100 μL LB buffer (the final dilution ratio=1:2×10⁴) and plated onto the LB agar plates.

### Evaluation of SARS-CoV-2 Pseudovirus Fouling on the Surfaces

Considering ACE2 as the entry receptor for SARS-CoV-2 infection, we used ACE2-overexpressing HEK293T cells for SARS-CoV-2 pseudovirus infection. The ACE2-overexpressing HEK293T cells were seeded in 12-well plates at a density of 2×10⁵ cells/well and incubated for 24 hours. PS, SCS, and DRT surfaces were cleaned according to the designated procedure, sterilized with 75% ethanol, and deposited in 12-well plates. Subsequently, 20 μL SARS-CoV-2 pseudoviral solution (2×10⁴ infectious unit/μL) were loaded onto the surfaces and incubated. After incubation, 1 mL of fresh medium was used to resuspend and recycle the SARS-CoV-2 pseudovirus. The pseudovirus-containing medium was supplemented with 8 ug/mL polybrene (Merck, Kenilworth, NJ, USA), and then ACE2-overexpressing HEK293T cells were shifted to this medium for SARS-CoV-2 pseudovirus infection. The 12-well plate was centrifuged at 2,000 rpm for 1 hour (Kubota, Bunkyo-ku, Tokyo) to enhance infection and then replaced with a fresh medium for further incubation. After two days, cells were harvested, and the cell lysates were subjected to luciferase reporter assay (Catalog #E1500, Promega, Madison, WI, USA) or quantitative real-time PCR.

### Quantitative Real-Time PCR (qPCR)

The viral RNA was isolated from the SARS-CoV-2 pseudovirus using the Viral Nucleic Acid Extraction Kit II (Catalog No. VR100, Geneaid, Taipei, Taiwan) and stored in RNase-free water. The cDNA was reverse-transcribed with SuperScript III (Invitrogen, Waltham, MA, USA) using GeneAmp PCR System 9700 thermocycler (Applied Biosystems, Waltham, MA, USA). The qPCR was performed on QuantStudio 3 real-time PCR systems (Applied Biosystems, Life Technologies, Carlsbad USA) according to the reaction protocol: pre-denaturation at 94° C. for 5 min, followed by 25 to 30 cycles of denaturation at 94° C. for 30 s, annealing at 58-62° C. for 30 s, and extension at 72° C. for 45 s. The mean Ct values were further taken to validate the virus RNA content on each chip. The primer sequences used for qPCR are qLuc_Forward: 5′-TGA ACA TCA CGT ACG CGG AA-3′; qLuc_Reverse 5′-TCC GAT AAA TAA CGC GCC CA-3′.

### Luciferase Reporter Assay

Two days after infection by the viral samples from the surfaces, ACE2-overexpressing HEK293T cells were harvested with the Passive Lysis Buffer for Promega luciferase assay (Catalog #E1500, Promega, Madison, WI, USA). The luciferase assay was conducted according to the manufacturer's instructions for use. The lysates were added with Luciferase Assay Reagent II (LAR II) to generate luminescence. For analysis, the luminescent photos were taken with UVP ChemStudio PLUS Imaging System (Analytik Jena AG, Thuringia, Germany). The luciferase signals were quantified using the Image J software.

### Scanning Electron Microscopy (SEM) Photographing and Energy Dispersive Spectrometer (EDS)

After removing non-adherent bacteria or pseudoviruses by buffer washing, the remnant bacteria or pseudoviruses were fixed with paraformaldehyde for 30 min and dehydrated by increasing ethanol concentrations (70%, 80%, 90%, and 100%) at a 20-min interval. The surfaces with adherent micro-organisms were air-dried in a laminar flow hood overnight. Subsequently, the surface samples were coated with gold (JFC-1200 Auto Fine Coater, Japan) and subjected to electron microscopy (JEOL JEM-2000EXII, Japan). The elemental analysis of different surfaces in SEM was performed simultaneously using energy dispersive spectroscopy (EDS).

### Statistical Analysis

The schematic diagrams were drawn using Solidworks and Microsoft PowerPoint. The line charts were plotted using Microsoft Excel. Data were expressed as mean±standard deviation (SD). Statistical differences between 2 groups or among multiple groups were detected by an unpaired two-tailed Welch's t-test or an unpaired one-way Brown-Forsythe and Welch's ANOVA with Dunnett's T3 multiple comparisons test (DRT surfaces as the control group), respectively, using Prism version 8 (Chicago, IL, USA). The criterion for significance was set as p<0.05, and highly significant differences in the statistics were accepted if p<0.001. All data presented are representative of at least 3 independent experiments.

### Results and Discussion

### Design and Characteristics of Different Surfaces

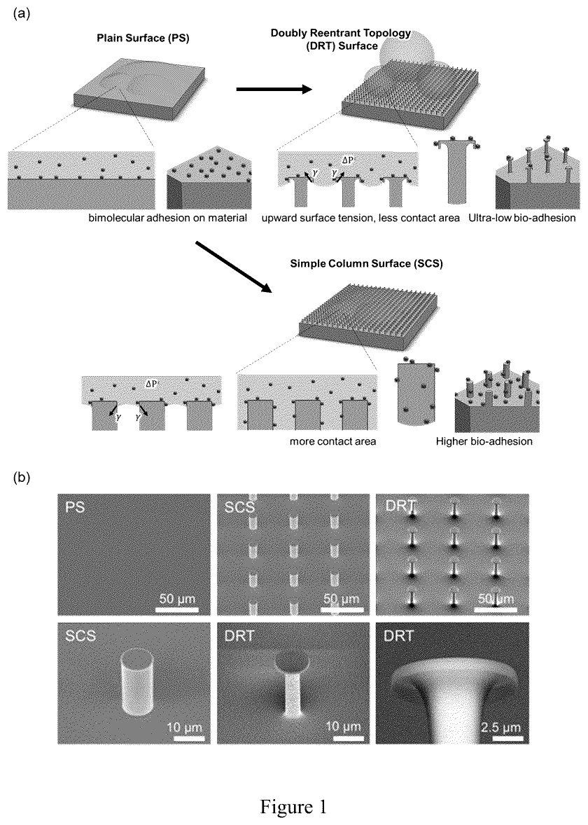

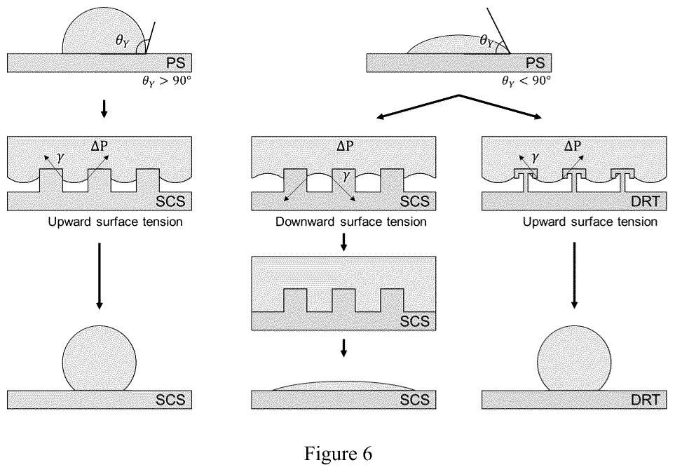

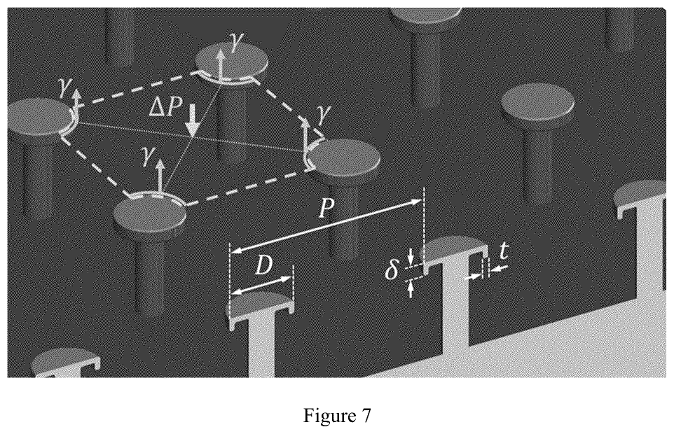

We used two other surfaces, i.e., plain surface (PS) and simple column surface (SCS), for comparison with the DRT surface (FIG. 1). The PS represents characteristics of the pure material so that the intrinsic contact angle (i.e., Young's angle) and the biofouling ability of the material itself could be determined. The SCS, which is the most common design of a structured surface made of hydrophobic materials or coatings for enhancing liquid repellency, is a square array of circular posts. However, for many hydrophilic materials, including SiO₂ and copper, used in this invention, the SCS design would reduce the liquid repellency of the surface instead. For hydrophilic liquids, the downward surface tension on the SiO₂-SCS causes the structure to be immersed in the liquid, which further increases the contact area, as shown in FIG. 1a and FIG. 6. The larger contact area leads to increased biofouling on the surface. In contrast, the upward force could be optimally achieved on the DRT surface to suspend liquids, enhancing the liquid repellency and decreasing the contact area, further reducing the fouling of biomolecules. The geometric parameters of DRT are shown in FIG. 7. The fabrication process of the surfaces is described in the Method.

### Contact Angle, Liquid Repellency, and Contact Area on Surfaces. FIG. 1a

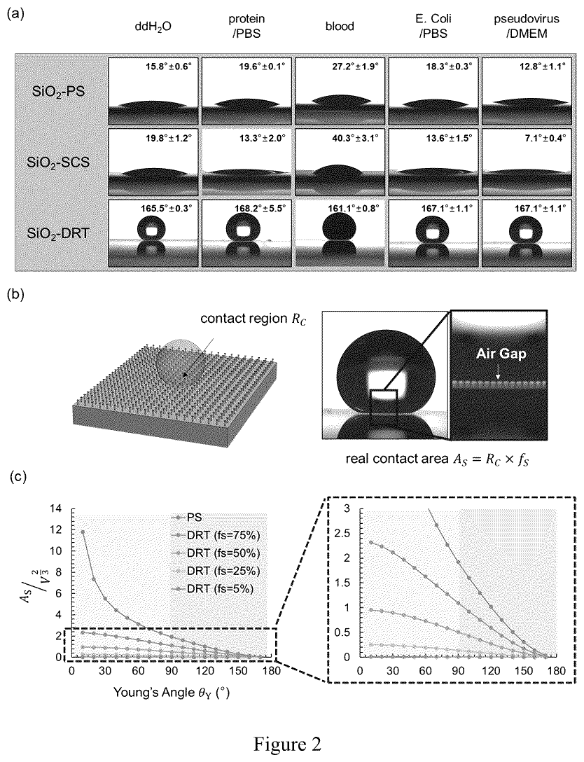

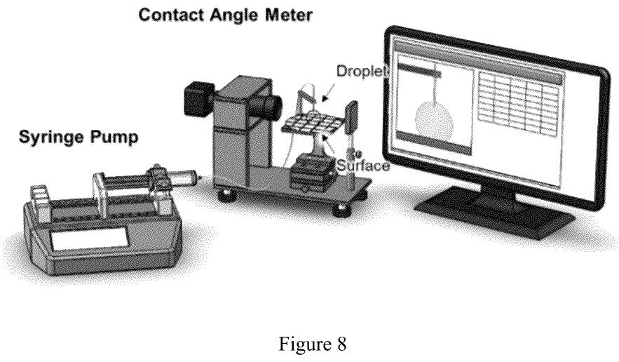

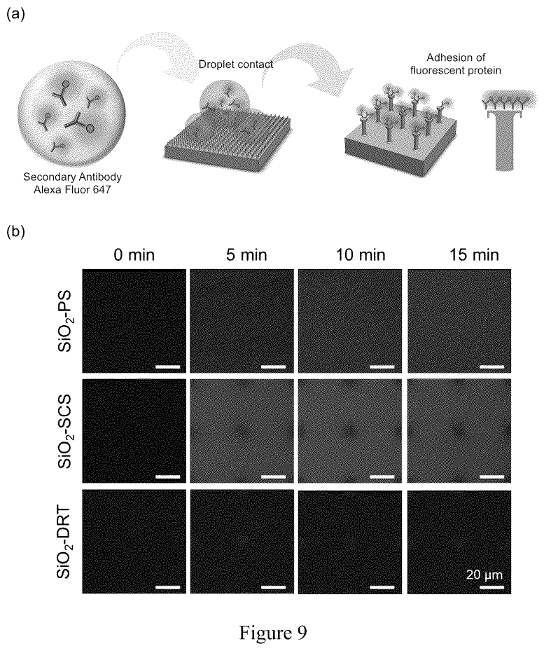

The superhydrophobic property is characterized by the surface roughness of large contact angles) (>150° and low hysteresis angles. [21] The contact angle was measured through a syringe pump and a contact angle meter, see FIG. 8. The test liquids included double-distilled water (ddH₂O), protein in phosphate-buffered saline (PBS), blood, bacteria in PBS, and viruses in Dulbecco's modified eagle medium (DMEM). The photos of the static contact angle of all five solutions are shown in FIG. 2a. For the SiO₂-PS, all five solutions' intrinsic contact angles were 12.8° to 27.2°. For the SiO₂-SCS, the contact angles ranged from 7.1° to 40.3°. Finally, for the SiO₂-DRT surface, all the solutions were wholly suspended on surfaces with large contact angles ranging from 161.1° to 168.2°. As the contact angles increase, liquids are more likely to be suspended on a surface with less contact area. The contact angles should be at least 150° for liquids to be fully suspended on surfaces (i.e., superhydrophobic). Only the SiO₂-DRT surface can fulfill this requirement. We also tested the antibiofouling performance of the SiO₂-DRT surface at a tilted angle. As in FIG. 9, the droplet of ddH₂O and blood quickly rolled off the tilted SiO₂-DRT surface within 3.5 seconds.

The theoretical basis of liquid repellency on a smooth or structured surface is described below. Droplets can be categorized into the Wenzel-droplets or the Cassie-droplets, which completely wet surfaces or are suspended by surfaces.^{[22]} A specially structured surface is required to reach the Cassie state for low-energy fluids.^{[20]} The contact angle of Cassie-droplets can be evaluated by the Cassie-Baxter Equation (1)

$$cos {θ}^{*} = {f}_{s} cos {θ}_{Y} - {f}_{g} \qquad ( 1 )$$

$${f}_{s} = \frac{{A}_{s}}{{A}_{s} + {A}_{g}} , {f}_{g} = \frac{{A}_{g}}{{A}_{s} + {A}_{g}} \qquad ( 2 )$$

where θ* is the contact angle on a surface, fₛ is the liquid-solid fraction, f_{g} is the liquid-vapor fraction, Θ_{Y} is the intrinsic contact angle (also known as Young's angle), As is the liquid-solid area, and A_{g} is the liquid-vapor area. The SCS requires θ_{Y}>90° to suspend liquids. On the nanostructured DRT surface, the fₛ can be minimized to <6% so that the θ* can be successfully maximized to >150° even for θ_{Y}˜0°. The correlation between the contact angle and the contact region (in the macroscopic view, FIG. 2b) can be described as

$${R}_{C} = {A}_{s} + {A}_{g} = {π ( \frac{3 V}{{πtan}^{2} \frac{{θ}^{*}}{2} ( \frac{3}{sin {θ}^{*}} - tan \frac{{θ}^{*}}{2} )} )}^{\frac{2}{3}} \qquad ( 3 )$$

where R_{c} is the contact region (in the macroscopic view), and V is the volume of the liquid. The detailed deduction is in the Supporting Information. The real contact area between the liquid and the surface (in the microscopic view), i.e., Aₛ in Equation (2), equals R_{c}×fₛ. By replacing R_{c} with Aₛ/fₛ and θ* with θ_{Y} according to Equation (1), we can get

$$\frac{{A}_{s}}{{V}^{\frac{2}{3}}} = {{f}_{s} ( 3 {π}^{\frac{1}{2}} )}^{\frac{2}{3}} ( {f}_{s} ( cos {θ}_{Y} + 1 ) ) {( \frac{1}{2 + 3 ( {f}_{s} ( cos {θ}_{Y} + 1 ) ) - {( {f}_{s} ( cos {θ}_{Y} + 1 ) )}^{3}} )}^{\frac{1}{3}} \qquad ( 4 )$$

The correlation between Aₛ/V^{2/3} and the intrinsic contact angle (θ_{Y}) can be illustrated in FIG. 2c. Even if the intrinsic contact angle between a liquid and a surface is nearly zero, DRT surfaces can still exhibit repellency and increase their contact angle by decreasing fₛ. According to our deduction, DRT surfaces reduce the contact region (R_{c}) and minimize the real contact area (Aₛ). Especially for the condition of θ_{Y}<90°, the efficacy of reducing the Aₛ is even more prominent (FIG. 2c).

### Antibiofouling of Protein, Blood, Bacteria, and Viruses

The design of DRT could achieve superhydrophobicity by reaching remarkably decreased solid-liquid fraction (fₛ) described in Equations (2). Thus, we tested the antibiofouling performance of the promising DRT surfaces since their applications have not been demonstrated.

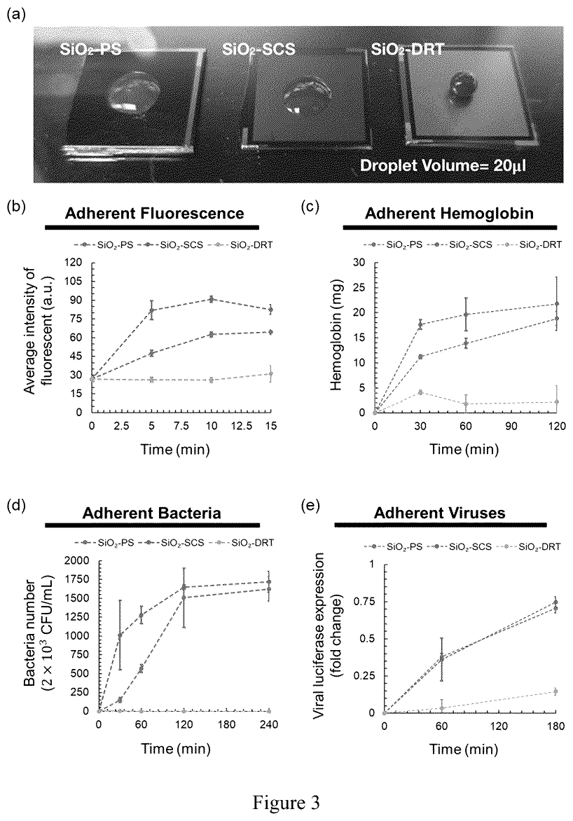

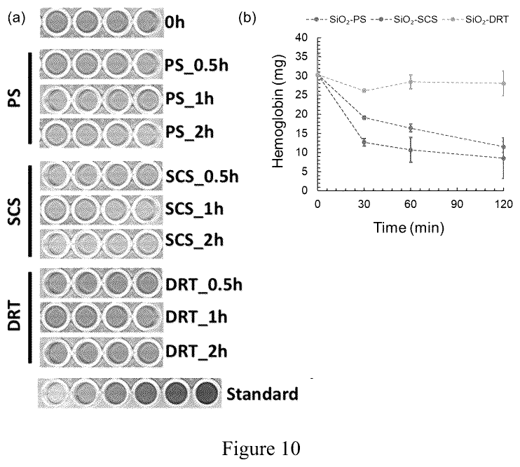

We compared the adhesion capacity of protein (with fluorescence), blood (FIG. 3a), bacteria, and viruses on the SiO₂-PS, SiO₂-SCS, and SiO₂-DRT surface. The surfaces' fluorescence intensity could quantitatively measure the extent of fouling protein on the surfaces. Twenty microliters of the protein liquid at a 10 μg/mL concentration were placed on the tested surfaces for 5, 10, and 15 minutes. Then, we washed the tested surfaces with ddH₂O and measured the fluorescence intensity on the surfaces using a fluorescence microscope. The fluorescence photography of surfaces is shown in FIG. 10. For the SiO₂-PS, the fluorescence intensity increased over time and reached a plateau of 62.65 a.u. in approximately 10 minutes. For the SiO₂-SCS, the fluorescence intensity was even higher than SiO₂-PS because the SCS structure was immersed in liquids (FIG. 1a), resulting in increased contact area from the sidewalls of the columns. For the SiO₂-DRT surface, the fluorescence intensity was around 26.79 a.u. and did not significantly increase over time (FIG. 3b). Overall, the fouling protein on the SiO₂-DRT surface was much less than that on the SiO₂-PS and SiO₂-SCS because of less fluorescence intensity.

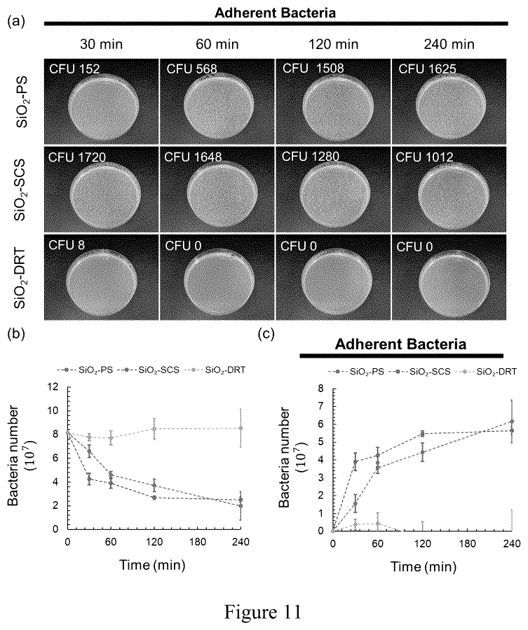

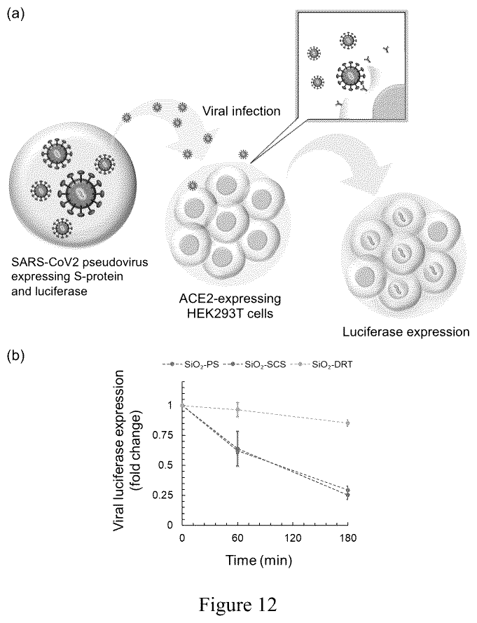

We then compared fouling blood on different surfaces. Twenty microliters of blood were placed on the tested surfaces for 0.5, 1, and 2 hours, respectively, and the adherent hemoglobin was quantified. FIG. 3c shows the amount of hemoglobin from the adherent blood. The adherent hemoglobin was calculated by subtracting collected hemoglobin of washing PBS from the initial amount of loading hemoglobin, and the original raw data were in FIG. 11. For the SiO₂-PS, the maximum adherent hemoglobin was about 18.86 mg. For the SiO₂-SCS, the curve was similar to that of the SiO₂-PS, and the maximum adherent hemoglobin was approximately 21.80 mg. For the SiO₂-DRT surface, the maximum adherent hemoglobin was only 2.26 mg. The fouling hemoglobin on the SiO₂-DRT surface was much less than that on the SiO₂-PS and SiO₂-SCS. We also tested if prolonged blood contact would alter the DRT geometry and its superrepellency. As in FIG. 12, the SEM imaging demonstrated no alteration of the DRT geometry, and the contact angles were all >150° after 0-, 12-, 24-, and 36-hour contact.

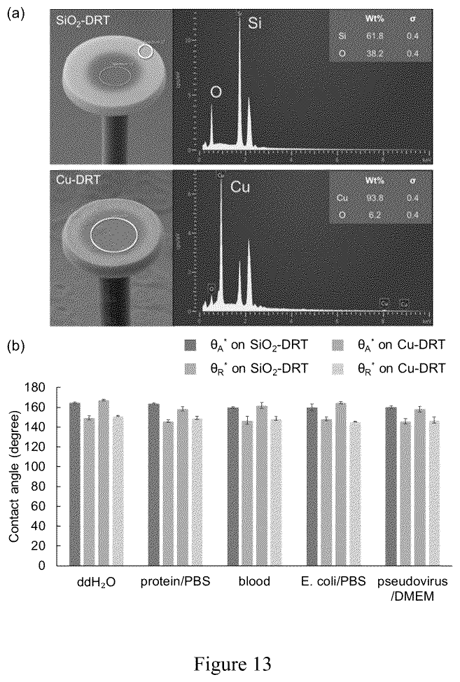

Next, we compared the antifouling ability of different surfaces against bacterial adhesion. Escherichia coli (E. coli) was utilized in the bacterial adhesion test. We assessed the bacteria fouling using the colony-forming unit (CFU) method, see FIG. 13a. Twenty microliters of E. coli in PBS solution were placed on the tested surfaces for 0.5, 1, 2, and 4 hours (FIG. 3d). The number of adherent bacteria on the SiO₂-DRT surface was minimal throughout the 4-hour contact time. In contrast, the adherent bacteria were significantly more on the PS and SCS and increased over time. We also used the spectrophotometric method to measure the OD value of 600 nm wavelength to quantify adherent bacteria and obtained similar results, see FIG. 13b/c. The fouling bacteria on the SiO₂-DRT surface was nearly undetectable and much less than those on the SiO₂-PS and SiO₂-SCS.

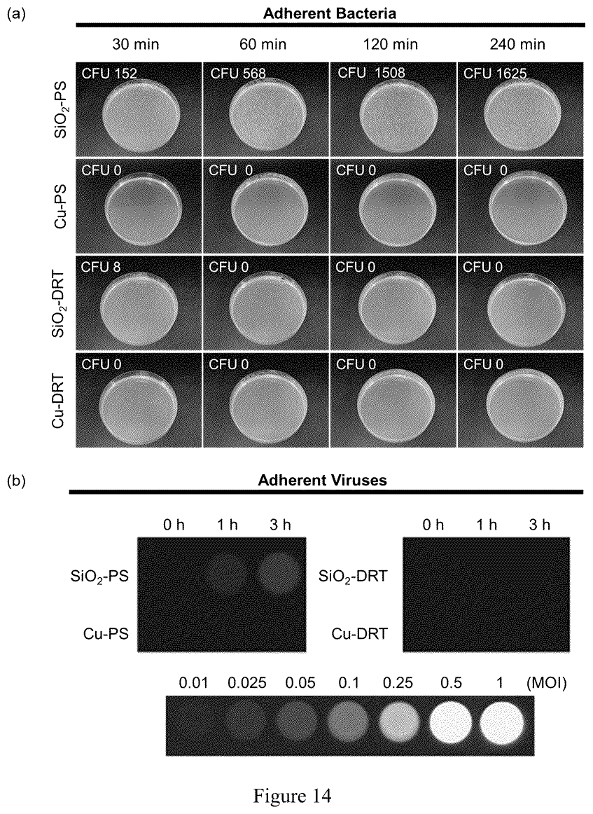

The virus adhesion test was conducted using SARS-CoV-2 pseudoviruses. SARS-CoV-2 pseudovirus that carries SARS-CoV-2 spike(S) protein is an artificial virus widely used to investigate SARS-CoV-2 virology and the viral entry into target cells. The SARS-CoV-2 pseudovirus was obtained from the National RNAi Core of Academia Sinica in Taiwan and generated by the transfection of 293T cells using a lentiviral backbone plasmid encoding the fluorescent reporter protein and the S protein, see FIG. 14a.^{[24]} Twenty microliters of SARS-CoV-2 pseudovirus in DMEM solution (2×10⁴ infectious units in 20uL) were placed on the tested surfaces for 0.5, 1, 2, and 3 hours, respectively. The viral fouling on the surfaces was examined by the expression of luciferase. Next, we subjected the adherent viruses to infecting ACE2-overexpressing HEK293T cells that proliferated within the cells. The adherent viruses were estimated by subtraction of the collected viruses in washing PBS from the total loading amount of the viral solution. The viral RNA was extracted, and the viral amount was evaluated by measuring the luciferase expression using quantitative real-time PCR, see FIG. 14b. The adherent virus replicative activity indicated only slight fouling of SARS-CoV-2 pseudoviruses on the SiO₂-DRT surface. However, the viral fouling and replication increased over time on the SiO₂-PS and the SiO₂-SCS (FIG. 3e).

### SEM Images of Bacteria and Viruses on Different Surfaces

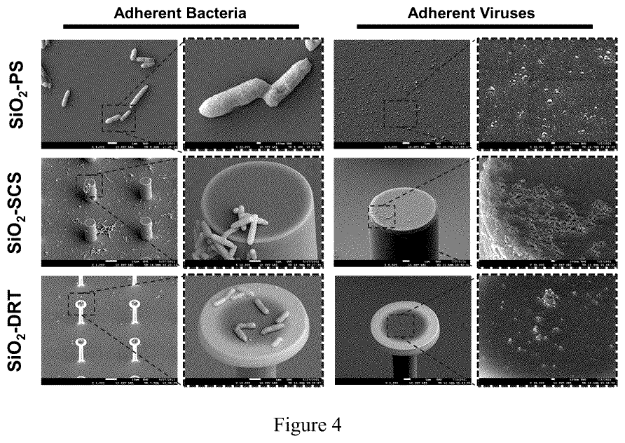

The SEM images of adherent bacteria on the SiO₂-PS, SiO₂-SCS, and SiO₂-DRT surface are shown in FIG. 4. E. coli were widely spread on the SiO₂-PS, and the putative morphology of E. coli could be observed. On the SiO₂-SCS, the adherent bacteria could be found on both the columns' tops and sidewalls. As for the SiO₂-DRT surface, we could not find any adherent bacteria initially. Therefore, we concentrated the bacterial solution five hundred times and applied it to the SiO₂-DRT surface. The bacteria only adhered to the top of the SiO₂-DRT surface since the droplet only contacted the tops of the DRT structure. This mushroom-like geometry could decrease bacterial fouling because of the minimal contact area.

The SEM images of adherent viruses are also shown in FIG. 4. To avoid confounding by the constituents and debris in the DMEM, we used ultracentrifuges to concentrate the viral particles. Next, we resuspended the pellet in PBS solution. The viral particles were spread over the surfaces after applying the SARS-CoV-2 pseudovirus/PBS solution. Fouling SARS-CoV-2pseudoviruses could be observed on the SiO₂-PS and the tops and sidewalls of the SiO₂-SCS. However, we could not see the viral fouling on the SiO₂-DRT surface under the same condition. Thus, we applied a 100× concentrated SARS-CoV-2 pseudovirus/PBS solution onto this surface. Because of the minimal contact area, only a few amounts of viral particles could be observed on the tops of the SiO₂-DRT surface. Our findings indicated that the DRT geometry also effectively reduced the fouling of SARS-CoV-2 pseudoviruses.

### Copper Coating for Reducing Transmission of Pathogens

Various coating agents with antibiofouling ability have been applied with superhydrophobic structures to improve performance.[22, 25] Researchers have also developed several self-healing materials.[18] The well-defined sol-gel chemistry was utilized in the silica-colloid-based superhydrophobic coating, which could reduce the adsorption of common and highly pathogenic micro-organisms, such as Staphylococcus aureus and Pseudomonas aeruginosa.^{[26]} This makes silica-colloid-based coating a good application for biomedical devices. Antibiotics or other nature inhibitors could also be applied on the surfaces to kill micro-organisms and viruses. For example, Patir et al. impregnated crystal violet, a common disinfectant, on a slippery surface to prevent bacterial contamination.^{[28]}

The use of copper and its alloys has been beneficial for reducing contact-mediated infections. Although the detailed mechanisms of copper's antimicrobial/antiviral activity are not fully understood, copper ions released from the copper surface are believed to play a significant role in these actions.^{[29]} The copper ions can cause depletion of sulfhydryls such as cysteine and glutathione, leading to the oxidation of proteins and lipids as the following reactions:

$$2 {Cu}^{2 +} + 2 R SH \to 2 {Cu}^{+} + R SS R + 2 {H}^{+} \qquad ( 5 )$$

$$2 {Cu}^{+} + 2 {H}^{+} + {O}_{2} \to 2 {Cu}^{2 +} + {H}_{2} {O}_{2} \qquad ( 6 )$$

The resulting hydrogen peroxide subsequently participates in the Fenton reaction (7) and generates highly reactive hydroxyl radicals, leading to the biomolecular damage and inactivation of DNA or RNA.^{[13, 29]}

$${Cu}^{+} + {H}_{2} {O}_{2} \to {Cu}^{2 +} + {OH}^{-} + {OH}^{\cdot } \qquad ( 7 )$$

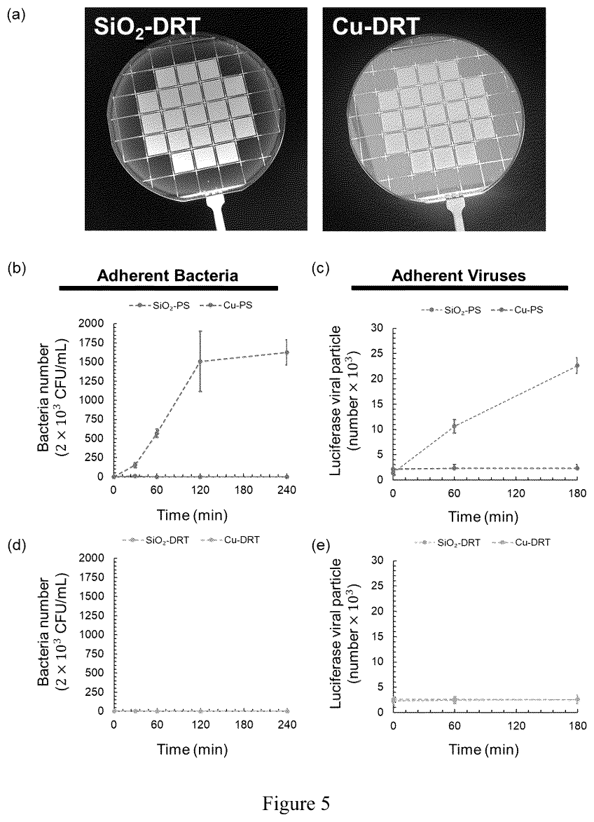

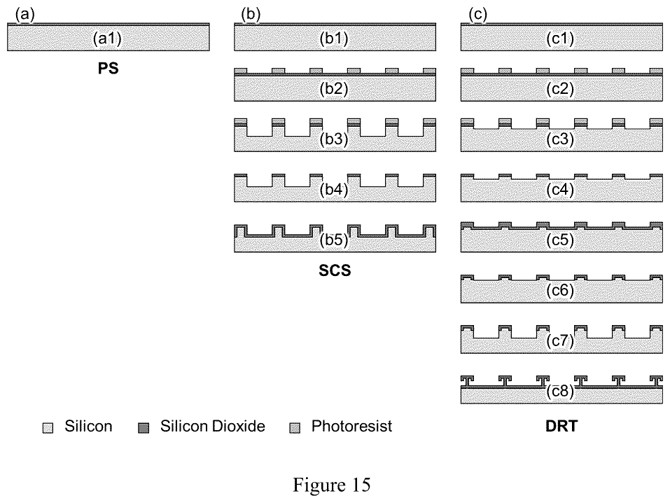

Although the oxide formation on copper may occur after a long time, even in standard ambient conditions, Hans et al. showed that copper oxides, including CuO and Cu₂O, still retained their outstanding antimicrobial properties.^{[+]} Researchers also observed that the survival time of SARS-CoV-2 on copper is significantly reduced to less than 4 hours compared to that on other materials such as steel (3-5 days), glass (4 days), wood (4-5 days), and plastics (≥5 days). In addition, compared with several existing materials, copper can be easily applied at a low cost. These advantages of copper have prompted us to coat it onto the DRT surface and examine if this combination (i.e., Cu-DRT) would exhibit both the superrepellent ability and antibacterial/antiviral efficacy, leading to the scavenging and extinction of pathogens at the same time. We successfully coated copper on the DRT surface (i.e., Cu-DRT, FIG. 5a, and FIG. 15a that did not alter the DRT geometry and its superrepellency. As expected, the Cu-DRT showed large contact angles and low hysteresis angles, see FIG. 15b.

We compared the antifouling effect between the PS and the DRT surface with or without the copper coating. To examine the fouling of bacteria or viruses and the copper-mediated scavenging potential against bacteria/viruses, the adherent bacteria or viral particles on the surfaces were detached by trypsinization. The bacterial fouling on surfaces with or without the copper coating was assessed using the CFU method. The viral fouling was evaluated by the luciferase reporter assay after their replication in host cells. For the Cu-PS, no bacterial or viral activity was observed on the surface over time (FIG. 5b/c). This result validated the outstanding antibacterial and antiviral performance of copper again. For the DRT surfaces, the adherent bacteria and viruses were consistently much less than those on PS (FIG. 5d/e). The bacteria on the Cu-DRT surface was undetectable over time, while some colonies were found on the SiO₂-DRT after 30 minutes of contact. The viral particle number was similar between the SiO₂-DRT and Cu-DRT surface over time. By applying the unique DRT geometry, DRT surfaces can exhibit excellent antibiofouling ability against bacteria and viruses independent of materials and coatings. Cu coatings on DRT surfaces might help kill minimal residual bacteria and viruses to ensure the ultimate blockade of contamination.

Based on our results, the Cu-DRT surface with the putative geometry could effectively reduce the fouling of bacteria and viruses. Even if there are sporadic residual bacteria and viruses on the Cu-DRT surface, the copper coating will exhibit unusual activity that can ultimately extinguish the adherent bacteria and viruses. This kind of surface may have potential applications in biomedical devices or environments such as ceilings and walls of operation rooms to prevent bacterial and viral contamination.

### Conclusion

We demonstrated that the DRT surfaces could significantly reduce biofouling and viral contamination. Furthermore, despite their constituents being made of hydrophilic materials such as SiO₂ and copper, the DRT surfaces can still substantially minimize the contact area with liquid. Currently existing antibiofouling surfaces usually require hydrophobic or antiviral coatings such as copper, [4-6] cationic polymers, [7] photodynamic polymers, [8] hydrogels, [9] nanoparticles, [4, 5, 10] graphene, [4, 11] etc. Unlike conventional surfaces, the antibiofouling and superrepellent abilities of DRT surfaces do not depend on their materials or coatings but on their unique geometry. This characteristic helps with the realization of various applications for DRT surfaces. The unique DRT geometry contributes to the antibiofouling performance of the DRT surfaces and results in a physical antibiofouling effect. Thus, coatings such as copper could be applied on DRT surfaces to potentially enhance antibiofouling ability. As described previously, copper is a promising candidate that can be coated on surfaces for contact-killing pathogens, including SARS-CoV-2.^{[32]} Although SARS-CoV-2 is transmitted predominantly by air-borne routes, frequent environmental contamination of SARS-CoV-2 has been reported in patient care services such as emergency departments and intensive care units.^{[33]} The possibility of SARS-CoV-2 fomite transmission cannot be entirely ruled out, and disinfection of frequently touched surfaces is still highly recommended.^{[34]} The geometry-based superrepellent properties exhibit unprecedented advantages for blocking the transmission of viruses or other micro-organisms, which is crucial to alleviate the COVID-19 pandemic.

While the present invention has been disclosed by way preferred embodiments, it is not intended to limit the present invention. Any person of ordinary skill in the art may, without departing from the spirit and scope of the present invention, shall be allowed to perform modification and embellishment. Therefore, the scope of protection of the present invention shall be governed by which defined by the claims attached subsequently.

### REFERENCES

### [1] E. A. Meyerowitz, A. Richterman, R. T. Gandhi, P. E. Sax, Ann Intern Med 2021, 174, 69.

### [2] E. Goldman, The Lancet Infectious Diseases 2020, 20, 892.

[3] H. Kanamori, J Infect 2021, 82, e17; A. N. M. Kraay, M. A. L. Hayashi, D. M. Berendes, J. S. Sobolik, J. S. Leon, B. A. Lopman, Emerg Infect Dis 2021, 27, 1229.

### [4] I. Das Jana, P. Kumbhakar, S. Banerjee, C. C. Gowda, N. Kedia, S. K. Kuila, S. Banerjee, N. C. Das, A. K. Das, I. Manna, C. S. Tiwary, A. Mondal, ACS Applied Nano Materials 2020, 4, 352.

### [5] S. Kumar, M. Karmacharya, S. R. Joshi, O. Gulenko, J. Park, G. H. Kim, Y. K. Cho, Nano Lett 2021, 21, 337.

### [6] A. Khorsand Kheirabad, X. Pan, S. Long, Z. Kochovski, S. Zhou, Y. Lu, G. McInerney, J. Yuan, Nano Sel 2021.

### [7] T. R. Sinclair, D. Robles, B. Raza, S. van den Hengel, S. A. Rutjes, A. M. de Roda Husman, J. de Grooth, W. M. de Vos, H. D. W. Roesink, Colloids and Surfaces A: Physicochemical and Engineering Aspects 2018, 551, 33.

### [8] B. S. T. Peddinti, F. Scholle, R. A. Ghiladi, R. J. Spontak, ACS Appl Mater Interfaces 2018, 10, 25955.

### [9] M. Korogiannaki, L. Jones, H. Sheardown, Langmuir 2019, 35, 950.

### [10] C. L. de Dicastillo, M. G. Correa, F. B. Martínez, C. Streitt, M. J. Galotto, in Titanium Dioxide, IntechOpen, 2020; P. Merkl, S. Long, G. M. McInerney, G. A. Sotiriou, Nanomaterials (Basel) 2021, 11.

### [11] A. J. Galante, K. A. Yates, E. G. Romanowski, R. M. Q. Shanks, P. W. Leu, ACS Applied Nano Materials 2022, 5, 718.

### [12] K. Delgado, R. Quijada, R. Palma, H. Palza, Lett Appl Microbiol 2011, 53, 50.

### [13] C. Poggio, M. Colombo, C. R. Arciola, T. Greggi, A. Scribante, A. Dagna, Materials (Basel) 2020, 13.

### [14] M. Hans, A. Erbe, S. Mathews, Y. Chen, M. Solioz, F. Mücklich, Langmuir 2013, 29, 16160; E. M. Culbertson, V. C. Culotta, Seminars in Cell & Developmental Biology 2021.

### [15] A. B. D. Cassie, S. Baxter, Nature 1945, 155, 21.

### [16] M. Liu, S. Wang, L. Jiang, Nature Reviews Materials 2017, 2.

### [17] L. Feng, S. Li, Y. Li, H. Li, L. Zhang, J. Zhai, Y. Song, B. Liu, L. Jiang, D. Zhu, Advanced Materials 2002, 14, 1857.

### [18] S. Liu, W. Guo, Advanced Functional Materials 2018, 28.

### [19] A. Grigoryev, I. Tokarev, K. G. Kornev, I. Luzinov, S. Minko, J Am Chem Soc 2012, 134, 12916.

### [20] T. L. Liu, C. J. Kim, Science 2014, 346, 1096.

### [21] M. J. Kreder, J. Alvarenga, P. Kim, J. Aizenberg, Nature Reviews Materials 2016, 1.

### [22] J. Yong, F. Chen, Q. Yang, J. Huo, X. Hou, Chem Soc Rev 2017, 46, 4168.

[23] J. Shang, Y. Wan, C. Luo, G. Ye, Q. Geng, A. Auerbach, F. Li, Proc Natl Acad Sci U S A 2020, 117, 11727; A. Muik, A. K. Wallisch, B. Sanger, K. A. Swanson, J. Muhl, W. Chen, H. Cai, D. Maurus, R. Sarkar, O. Tureci, P. R. Dormitzer, U. Sahin, Science 2021, 371, 1152.
[24] H. I. Ahmad Mulyadi Lai, S. J. Chou, Y. Chien, P. H. Tsai, C. S. Chien, C. C. Hsu, Y. C. Jheng, M. L. Wang, S. H. Chiou, Y. B. Chou, D. K. Hwang, T. C. Lin, S. J. Chen, Y. P. Yang, Int J Mol Sci 2021, 22; C. Y. Lee, C. H. Huang, E. Rastegari, V. Rengganaten, P. C. Liu, P. H. Tsai, Y. F. Chin, J. R. Wu, S. H. Chiou, Y. C. Teng, C. W. Lee, Y. Liang, A. Y. Chen, S. C. Hsu, Y. J. Hung, J. R. Sun, C. S. Chien, Y. Chien, Int J Mol Sci 2021, 22.

### [25] P. Zhang, L. Lin, D. Zang, X. Guo, M. Liu, Small 2017, 13.

### [26] B. J. Privett, J. Youn, S. A. Hong, J. Lee, J. Han, J. H. Shin, M. H. Schoenfisch, Langmuir 2011, 27, 9597.

### [27] Q. Yu, Y. Yuan, J. Wen, X. Zhao, S. Zhao, D. Wang, C. Li, X. Wang, N. Wang, Adv Sci (Weinh) 2019, 6, 1900002; Z. Sun, K. Ostrikov, Sustainable Materials and Technologies 2020, 25.

### [28] A. Patir, G. B. Hwang, C. Lourenco, S. P. Nair, C. J. Carmalt, I. P. Parkin, ACS Appl Mater Interfaces 2021, 13, 5478.

### [29] G. Grass, C. Rensing, M. Solioz, Appl Environ Microbiol 2011, 77, 1541.

### [30] M. Hans, A. Erbe, S. Mathews, Y. Chen, M. Solioz, F. Mucklich, Langmuir 2013, 29, 16160.

### [31] N. van Doremalen, T. Bushmaker, D. H. Morris, M. G. Holbrook, A. Gamble, B. N. Williamson, A. Tamin, J. L. Harcourt, N. J. Thornburg, S. I. Gerber, J. O. Lloyd-Smith, E. de Wit, V. J. Munster, N Engl J Med 2020, 382, 1564.

### [32] A. P. A. Carvalho, C. A. Conte-Junior, Glob Chall 2021, 2000115; M. Hosseini, A. W. H. Chin, S. Behzadinasab, L. L. M. Poon, W. A. Ducker, ACS Appl Mater Interfaces 2021, 13, 5919.

### [33] G. Ye, H. Lin, S. Chen, S. Wang, Z. Zeng, W. Wang, S. Zhang, T. Rebmann, Y. Li, Z. Pan, Z. Yang, Y. Wang, F. Wang, Z. Qian, X. Wang, J Infect 2020, 81, el.

### [34] D. Lewis, Nature 2021, 590, 26.

What is claimed is:

1. An anti-biofouling artificial surface comprising:
a superhydrophobic surface; thereon a plurality of microstructures and having a doubly re-entrant topology (DRT) situated atop respective base structures, wherein the doubly re-entrant topology (DRT) comprises a cap portion, a downwardly extending lip extending from a periphery of the cap portion and a copper coating layer; wherein the superhydrophobic surface roughness of large contact angles and lower hysteresis angle.

2. The anti-biofouling artificial surface of claim 1, wherein the superhydrophobic surface roughness of large contact angles is less than 150°.

3. The anti-biofouling artificial surface of claim 1, wherein the thickness of the cap portion is substantially equal to the thickness of the downwardly extending lip.

4. The anti-biofouling artificial surface of claim 1, wherein the base material comprises silicon and the cap material comprises silicon dioxide.

5. The anti-biofouling artificial surface of claim 1, wherein the superhydrophobic surface remains repellant to fouling fluids after long-term exposure.

6. The anti-biofouling artificial surface of claim 1, wherein the surface exhibits anti-biofouling properties after long-term exposure.

7. The anti-biofouling artificial surface of claim 1, wherein the copper coating comprises copper and its alloys.

8. The anti-biofouling artificial surface of claim 1, wherein the copper coating comprises copper and its alloys.

9. The anti-biofouling artificial surface of claim 1, wherein the superhydrophobic surface comprises whether hydrophobic or hydrophilic material.

10. A method of promoting anti-biofouling and prevention of pathogens comprising: using an anti-biofouling artificial surface comprising:
a superhydrophobic surface; thereon a plurality of microstructures and having a doubly re-entrant topology (DRT) situated atop respective base structures, wherein the doubly re-entrant topology (DRT) comprises a cap portion, a downwardly extending lip extending from a periphery of the cap portion and a copper coating layer; wherein the superhydrophobic surface roughness of large contact angles and lower hysteresis angle.

11. The method of promoting anti-biofouling and prevention of pathogens of claim 10, wherein the superhydrophobic surface roughness of large contact angles is less than 150°.

12. The method of promoting anti-biofouling and prevention of pathogens of claim 10, wherein the thickness of the cap portion is substantially equal to the thickness of the downwardly extending lip.

13. The method of promoting anti-biofouling and prevention of pathogens of claim 10, wherein the base material comprises silicon and the cap material comprises silicon dioxide.

14. The method of promoting anti-biofouling and prevention of pathogens of claim 10, wherein the superhydrophobic surface remains repellant to fouling fluids after long-term exposure.

15. The method of promoting anti-biofouling and prevention of pathogens of claim 10, wherein the surface exhibits anti-biofouling properties after long-term exposure.

16. The method of promoting anti-biofouling and prevention of pathogens of claim 10, wherein the copper coating comprises copper and its alloys.

17. The method of promoting anti-biofouling and prevention of pathogens of claim 10, wherein the copper coating would not alter the DRT geometry or its super-repellent properties.

18. The method of promoting anti-biofouling and prevention of pathogens of claim 10, wherein the superhydrophobic surface comprises whether hydrophobic or hydrophilic material.

19. The method of promoting anti-biofouling and prevention of pathogens of claim 10, wherein the pathogen is an infectious microorganism or agent comprising a virus, bacterium, protozoan, prion, viroid, or fungus.

20. The method of promoting anti-biofouling and prevention of pathogens of claim 19, wherein the virus is SARS-CoV-2.
